(19) United States
(12) Patent Application Publication
(10) Pub. No.: US 2020/0050839 A1
(43) Pub. Date: Feb. 13, 2020

(54) HUMAN-TRACKING ROBOT

(71) Applicant: ROBO-TEAM HOME LTD., Tel Aviv (IL)

(72) Inventors: Yosef Arie WOLF, Tel Aviv (IL); Gal GOREN, Beit Oren (IL); Efraim VITZRABIN, Holon (IL); Roee FINKELSHTAIN, Tel Aviv (IL)

(21) Appl. No.: 16/343,046

(22) PCT Filed: Oct. 19, 2017
(86) PCT No.: PCT/IL2017/051156

§ 371 Date: Apr. 18, 2019

Related U.S. Application Data
(60) Provisional application No. 62/410,630, filed on Oct. 20, 2016.

(51) Int. Cl. G06K 9/00; B25J 9/16; B25J 11/00; G06K 9/62

(52) U.S. Cl. CPC G06K 9/00342; B25J 9/1602; B25J 9/163; G06K 9/6221; B25J 9/1697; B25J 11/008; B25J 9/1679

(57) ABSTRACT

A robot, method and computer program product, the method comprising: receiving a collection of points in at least two dimensions; segmenting the points according to distance to determine at least one object; tracking the at least one object; subject to at least two objects of size not exceeding a first threshold and at a distance not exceeding a second threshold, merging the at least two objects; and classifying a pose of a human associated with the at least one object.

### TECHNICAL FIELD

The present disclosure relates to the field of robotics.

### BACKGROUND

Automatically tracking or leading a human by a device in an environment is a complex task. The task is particularly complex in an indoor or another environment in which multiple static or dynamic objects may interfere with continuously identifying a human and tracking or leading the human.

The term “identifying”, unless specifically stated otherwise, is used in this specification in a relation to detecting a particular object such as a human over a period of time, from obtained information such as but not limited to images, depth information, thermal images, or the like. The term identification does not necessarily relate to associating the object with a specific identity, but rather to determining that objects detected in consecutive points in time are the same object.

The term “tracking”, unless specifically stated otherwise, is used in this specification in a relation to following, leading, tracking, instructing, or otherwise relating to a route taken by an object such as a human.

The foregoing examples of the related art and limitations related therewith are intended to be illustrative and not exclusive. Other limitations of the related art will become apparent to those of skill in the art upon a reading of the specification and a study of the figures.

### SUMMARY

One exemplary embodiment of the disclosed subject matter is a robot comprising: a sensor for capturing providing a collection of points in two or more dimensions, the points indicative of objects in an environment of the robot; a processor adapted to perform the steps of: receiving a collection of points in at least two dimensions; segmenting the points according to distance to determine at least one object; tracking the at least one object; subject to two or more objects of size not exceeding a first threshold and at a distance not exceeding a second threshold, merging the at least two objects; and classifying a pose of a human associated with the at least one object; a steering mechanism or changing a position of the robot in accordance with the pose of the human; and a motor for activating the steering mechanism.

Another exemplary embodiment of the disclosed subject matter is a method for detecting a human in an indoor environment, comprising: receiving a collection of points in two or more dimensions; segmenting the points according to distance to determine one or more objects; tracking the objects; subject to objects of size not exceeding a first threshold and at a distance not exceeding a second threshold, merging the objects into a single object; and classifying a pose of a human associated with the single object. The method can further comprise: receiving a series of range and angle pairs; and transforming each range and angle pair to a point in a two dimensional space. Within the method, segmenting the points optionally comprises: subject to a distance between two consecutive points not exceeding a threshold, determining that the two consecutive points belong to one object; determining a minimal bounding rectangle for each object; and adjusting the minimal bounding rectangle to obtain adjusted bounding rectangle for each object. Within the method, tracking the objects optionally comprises: comparing the adjusted bounding rectangle to previously determined adjusted bounding rectangles to determine: a new object, a static object or a dynamic object, wherein a dynamic object is determined subject to at least one object and a previous object having substantially a same size but different orientation or different location. Within the method, classifying the pose of the human optionally comprises: receiving a location of a human; processing a depth image starting from the location and expending to neighboring pixels, wherein pixels having depth information differing in at most a third predetermined threshold are associated with one segment; determining a gradient over a vertical axis for a multiplicity of areas of the one segment; subject to the gradient differing in at least a fourth predetermined threshold between a lower part and an upper part of an object or the object not being substantially vertical, determining that the human is sitting; subject to a height of the object not exceeding a fifth predetermined threshold, and a width of the object exceeding a sixth predetermined threshold determining that the human is lying; and subject to a height of the object not exceeding the fifth predetermined threshold, and the gradient being substantially uniform determining that the human is standing. The method can further comprise sub-segmenting each segment in accordance with the gradient over the vertical axis. The method can further comprise smoothing the pose of the person by determining the pose that is most frequent within a latest predetermined number of determinations. The method can further comprise adjusting a position of a device in accordance with a location and pose of the human. Within the method, adjusting the position of the device optionally comprises performing an action selected from the group consisting of: changing a location of the device; changing a height of the device or a part thereof, and changing an orientation of the device or a part thereof. Within the method, adjusting the position of the device is optionally performed for taking an action selected from the group consisting of: following the human; leading the human; and following the human from a front side.

Yet another exemplary embodiment of the disclosed subject matter is a computer program product comprising: a non-transitory computer readable medium; a first program instruction for receiving a collection of points in at least two dimensions; a second program instruction for segmenting the points according to distance to determine at least one object; a third program instruction for tracking the at least one object; a fourth program instruction for subject to at least two objects of size not exceeding a first threshold and at a distance not exceeding a second threshold, merging the at least two objects; and a fifth program instruction for classifying a pose of a human associated with the at least one object, wherein said first, second, third, fourth, and fifth program instructions are stored on said non-transitory computer readable medium. The computer program product may further comprise a program instructions stored on said non-transitory computer readable medium, the program instructions comprising: a program instruction for receiving a series of range and angle pairs; and a program instruction for transforming each range and angle pair to a point in a two dimensional space. Within the computer program product, the second program instruction optionally comprises: a program instruction for determining that the two consecutive points belong to one object, subject to a distance between two consecutive points not exceeding a threshold; a program instruction for determining a minimal bounding rectangle for each object; and a program instruction for adjusting the minimal bounding rectangle to obtain adjusted bounding rectangle for each object. Within the computer program product, the third program instruction optionally comprises: a program instruction for comparing the adjusted bounding rectangle to previously determined adjusted bounding rectangles to determine: a new object, a static object or a dynamic object, wherein a dynamic object is determined subject to at least one object and a previous object having substantially a same size but different orientation or different location. Within the computer program product, the fifth program instruction optionally comprises: a program instruction for receiving a location of a human; a program instruction for processing a depth image starting from the location and expending to neighboring pixels, wherein pixels having depth information differing in at most a third predetermined threshold are associated with one segment; a program instruction for determining a gradient over a vertical axis for a multiplicity of areas of the one segment; a program instruction for determining that the human is sitting subject to the gradient differing in at least a fourth predetermined threshold between a lower part and an upper part of an object or the object not being substantially vertical; a program instruction for determining that the human is lying, subject to a height of the object not exceeding a fifth predetermined threshold, and a width of the object exceeding a sixth predetermined threshold; and a program instruction for determining that the human is standing, subject to a height of the object not exceeding the fifth predetermined threshold, and the gradient being substantially uniform. The computer program product may further comprise a program instruction stored on said non-transitory computer readable medium for sub-segmenting each segment in accordance with the gradient over the vertical axis. The computer program product may further comprise a program instruction stored on said non-transitory computer readable medium for smoothing the pose of the person by determining the pose that is most frequent within a latest predetermined number of determinations. The computer program product may further comprise a program instruction stored on said non-transitory computer readable medium for adjusting a position of a device in accordance with a location and pose of the human. Within the computer program product, the program instruction for adjusting the position of the device may comprise a further program instruction for performing an action selected from the group consisting of: changing a location of the device; changing a height of the device or a part thereof, and changing an orientation of the device or a part thereof. Within the computer program product, the program instruction for adjusting the position of the device is optionally executed for taking an action selected from the group consisting of: following the human; leading the human; and following the human from a front side.

### BRIEF DESCRIPTION OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a schematic illustration of a device for identifying, tracking and leading a human, a pet or another dynamic object in an environment, which can be used in accordance with an example of the presently disclosed subject matter;

FIG. 1B shows another schematic illustration of the device for identifying, tracking and leading a human, a pet or another dynamic object in an environment, which can be used in accordance with an example of the presently disclosed subject matter;

FIG. 2 shows a functional block diagram of the tracking device of FIG. 1A or 1B, in accordance with an example of the presently disclosed subject matter;

FIG. 3 is a flowchart of operations carried out for detecting and tracking an object in an environment, in accordance with an example of the presently disclosed subject matter;

FIG. 4A is a flowchart of operations carried out for segmenting points, in accordance with an example of the presently disclosed subject matter;

FIG. 4B is a flowchart of operations carried out for tracking an object, in accordance with an example of the presently disclosed subject matter;

FIG. 4C is a flowchart of operations carried out for classifying a pose of a human, in accordance with an example of the presently disclosed subject matter;

FIG. 5A shows depth images of a standing person and a sitting person, in accordance with an example of the presently disclosed subject matter; and

FIG. 5B shows some examples of objects representing bounding rectangles and calculated depth gradients of objects, in accordance with an example of the presently disclosed subject matter.

### DETAILED DESCRIPTION

One technical problem handled by the disclosed subject matter relates to a need for a method and device for identifying and tracking an object such as a human. Such method and device may be used for a multiplicity of purposes, such as serving as a walker, following a person and providing a mobile tray or a mobile computerized display device, leading a person to a destination, following a person to a destination from the front or from behind, or the like. It will be appreciated that the purposes detailed above are not exclusive and a device may be used for multiple purposes simultaneously, such as a walker and mobile tray, which also leads the person. It will be appreciated that such device may use for other purposes. Identifying and tracking a person in an environment, and in particular in a multiple-object environment, including an environment in which there are other persons who may move, is known to be a challenging task.

Another technical problem handled by the disclosed subject matter relates to the need to identify and track a person in real-time or near-real-time, by using mobile capture devices or sensors for capturing or otherwise sensing the person, and a mobile computing platform. The required mobility of the device and other requirements impose processing power or other limitations. For example, high resource consuming image processing tasks may not be performed under such conditions, processor requiring significant power cannot be operated for extended periods of time on a mobile device, or the like.

One technical solution relates to a method for identifying and tracking a person, from a collection of two- or three-dimensional points describing coordinates of detected objects. Tracking may be done by a tracking device advancing in proximity to the person. The points may be obtained, for example, by receiving series of angle and distance pairs from a rotating laser transmitter and receiver located on the tracking device, and transforming this information to two- or three-dimensional points. Each such pair indicates the distance at which an object is found at the specific angle. The information may be received from the laser transmitter and receiver every 1 degree, 0.5 degree, or the like, wherein the laser transmitter and receiver may complete a full rotation every 0.1 second or even less.

The points as transformed may then be segmented according to the difference between any two consecutive points, i.e., points obtained from two consecutive readings received from the laser transmitter and receiver.

A bounding rectangle may then be defined for each such segment, and compared to bounding rectangles determined for previous cycles of the laser transmitter and receiver. The objects identified as corresponding to previously determined objects may be identified over time.

Based on the comparison, objects may be merged and split. Additionally, if two segments are relatively small and relatively close to each other, they may be considered as a single object, for example in the case of legs of a person.

Another technical solution relates to determining the pose of a human once the location is known, for example whether the person is sitting, standing or lying. Determining the position may be performed based on the gradient of the depth of pixels making up the object along a vertical axis, as calculated upon depth information obtained for example from a depth camera.

Once the location and position of the person is determined, the device may take an action, such as change its location, height or orientation in accordance with the person's location and pose, so as to provide the required functionality for the person, such as following, leading or following from the front.

One technical effect of the disclosed subject matter is the provisioning of an autonomous device that may follow or lead a person. The device may further adjust its height or orientation so as to be useful to the person, for example, the person may easily reach a tray of the autonomous device, view content displayed on a display device of the autonomous device, or the like.

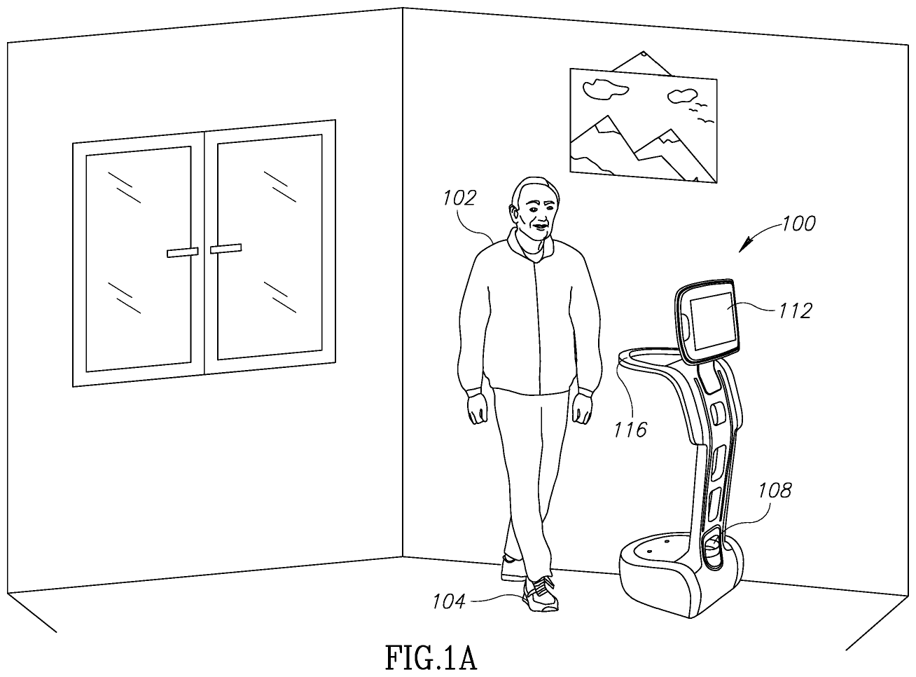

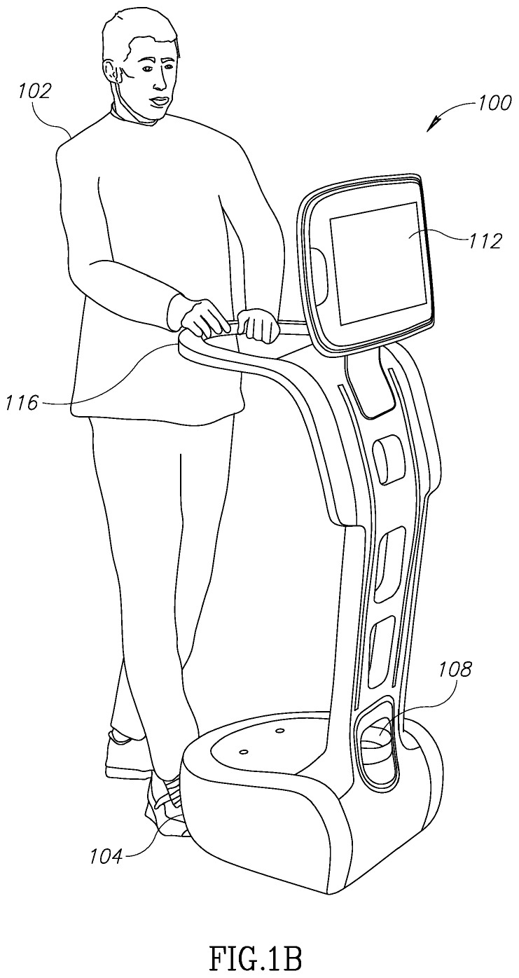

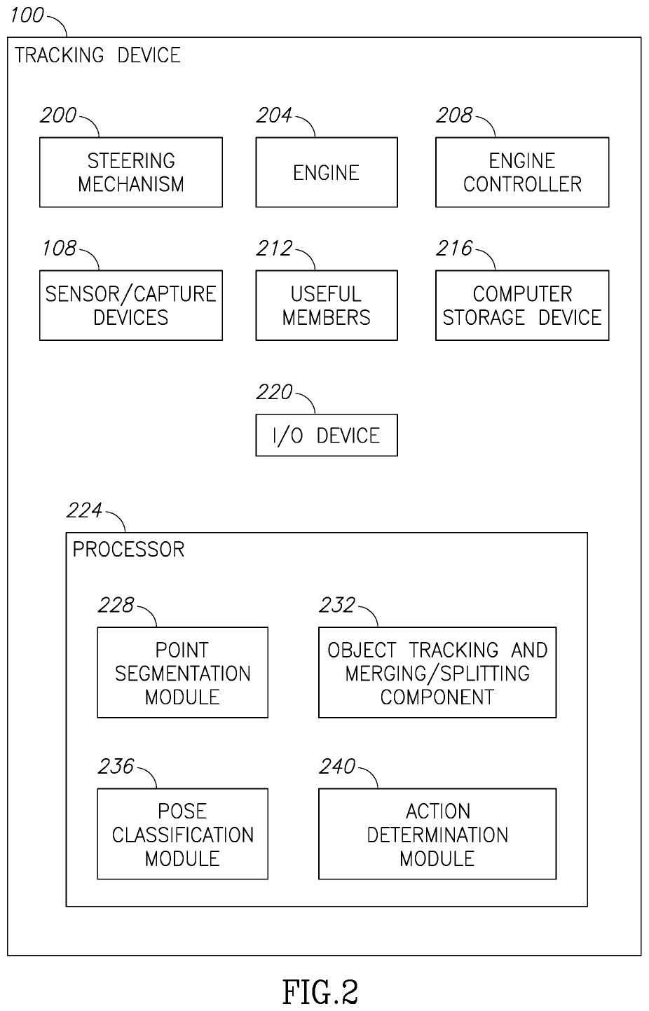

Referring now to FIGS. 1A and 1B, showing schematic illustrations of an autonomous device for identifying and tracking or leading a person, and to FIG. 2, showing a functional block diagram of the same.

FIG. 1A shows the device, generally referenced 100, identifying, tracking and leading a person, without the person having physical contact with the device. FIG. 1B shows device 100 identifying, tracking and leading the person, wherein the person is holding a handle 116 of device 100.

It will be appreciated that handle 116 can be replaced by or connected to a tray which can be used by the person for carrying things around, for example to the destination to which device 100 is leading the person.

Device 100 comprises a steering mechanism 200 which may be located at its bottom part 104, and comprising one or more wheels or one or more bearings, chains or any other mechanism for moving. Device 100 may also comprise motor 204 for activating steering mechanism 200, and motor controller 208 for providing commands to motor 204 in accordance with the required motion.

Device 100 may further comprise one or more sensors or capture devices 108, such as a laser receiver/transmitter, a camera which may provide RGB data or depth data, or additional devices, such as a microphone.

The laser receiver/transmitter may rotate and provide for each angle or for most angles around device 100, the distance at which the laser beam hit an object. The laser receiver/transmitter may provide a reading every 1 degree, every 0.5 degree, or the like.

Device 100 may further comprise useful members 212 such as tray 116, display device 112, or the like.

Display device 112 may display to a user another person, thus giving a feeling that a human instructor is leading or following the user, alerts, entertainment information, required information such as items to carry, or any other information. Useful members 212 may also comprise a speaker for playing or streaming sound, a basket, or the like

Device 100 may further comprise one or more computer storage devices 216 for storing data or program code operative to cause device 100 to perform acts associated with any of the steps of the methods detailed below. Storage device 216 may be persistent or volatile. For example, storage device 216 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like.

In some exemplary embodiments of the disclosed subject matter, device 100 may comprise one or more Input/Output (I/O) devices 220, which may be utilized to receive input or provide output to and from device 100, such as receiving commands, displaying instructions, or the like. I/O device 220 may include previously mentioned members, such as display 112, speaker, microphone, a touch screen, or others.

In some exemplary embodiments, device 100 may comprise one or more processors 224. Each of processors 224 may be a Central Processing Unit (CPU), a microprocessor, an electronic circuit, an Integrated Circuit (IC) or the like. Alternatively, processor 224 can be implemented as firmware programmed for or ported to a specific processor such as digital signal processor (DSP) or microcontrollers, or can be implemented as hardware or configurable hardware such as field programmable gate array (FPGA) or application specific integrated circuit (ASIC).

In some embodiments, one or more processor(s) 224 may be located remotely from device 100, such that some or all the computations are performed by a platform remote from the device and the results are transmitted via a communication channel to device 100.

It will be appreciated that processor(s) 224 can be configured to execute several functional modules in accordance with computer-readable instructions implemented on a non-transitory computer-readable storage medium, such as but not limited to storage device 216. Such functional modules are referred to hereinafter as comprised in the processor.

The components detailed below can be implemented as one or more sets of interrelated computer instructions, executed for example by processor 224 or by another processor. The components can be arranged as one or more executable files, dynamic libraries, static libraries, methods, functions, services, or the like, programmed in any programming language and under any computing environment.

Processor 224 can comprise point segmentation module 228, for receiving a collection of consecutive points, for example as determined upon a series of angle and distance pairs obtained from a laser transmitter/receiver, and segmenting them into objects.

Processor 224 can comprise object tracking and merging/splitting module 232, for tracking the objects obtained by point segmentation module 228 over time, and determining whether objects have been merged or split, for example distinguishing between two people or a person and a piece of furniture that were previously located one behind the other, identifying two legs as belonging to one human being, or the like.

Processor 224 can comprise pose classification module 236 for determining a pose of an object and in particular a human, determined by point segmentation module 228.

Processor 224 can comprise action determination module 240 for determining an action to be taken by device 100, for example moving to another location in accordance with a location of a human user, changing the height of device or part thereof such as tray 116 or display 112, playing a video or an audio stream, or the like.

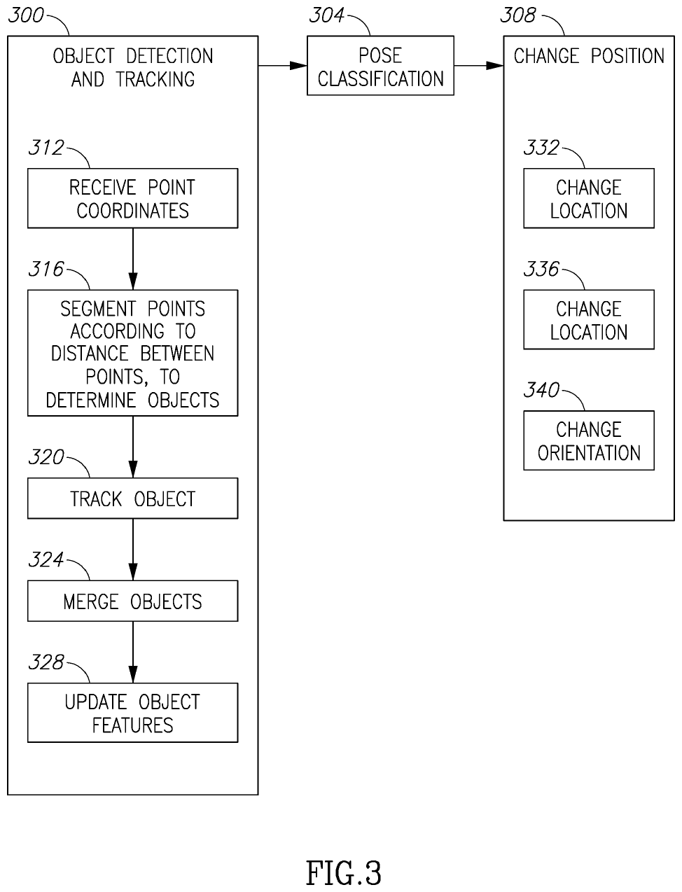

Referring now to FIG. 3, showing a flowchart of operations carried out for detecting and tracking an object in an environment.

On stage 300, one or more objects are detected and tracked. Stage 300 may include stage 312 for receiving point coordinates, for example in two dimensions. The points may be obtained by receiving consecutive pairs of angle and distance, as may be obtained by a laser transmitter/receiver, and projecting them onto a plane. It will be appreciated that normally, consecutive points will be obtained at successive angles, but this is not mandatory.

Stage 300 may further comprise point segmentation stage 316 for segmenting points according to the distances between consecutive points, in order to determine objects.

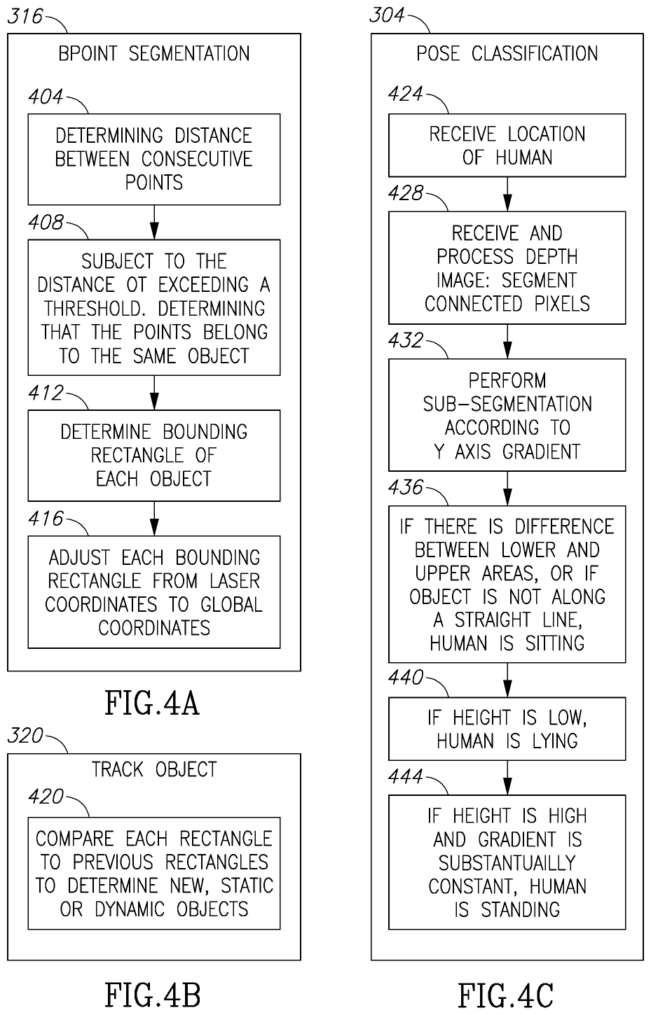

Referring now to FIG. 4A, showing a flowchart of operations carried out for segmenting points, thus detailing point segmentation stage 316.

Point segmentation stage 316 may comprise distance determination stage 404, for determining a distance between two consecutive points. The distance may be determined as a Euclidean distance over the plane.

On point segmentation stage 316, if the distance between two consecutive points, as determined on stage 404 is below a threshold, then it may be determined that the points belong to the same object. If the distance exceeds the threshold, the points are associated with different objects.

In a non-limiting example, the threshold may be set in accordance with the following formula:

tan(angle difference between two consecutive points)*Range(m)+C,

wherein the angle difference may be, for example, 1 degree, range (m) is the distance between the robot and the objects, for example 1 meter, and C is a small constant, for example between 0.01 and 1, such as 0.1, intended for smoothing errors such as rounding errors. Thus, for a range of 1 meter, angle difference of one meter, and constant of 0.05, the calculation is tan(1)*1+0.05=0.067. Thus, if the distance between the two points in the XY space is below 0.067m the points are considered as part of the same object, otherwise they are split into two separate objects.

On bounding rectangle determination stage 412, a bounding rectangle may be determined for each object, which rectangle includes all points associated with the object. The bounding rectangle should be as small as possible, for example the minimal rectangle that includes all points.

On bounding rectangle adjustment stage 416, the bounding rectangles determined on stage 412 may be adjusted in accordance with localization information about the position and orientation of the laser transmitter/receiver, in order to transform the rectangles from the laser transmitter/receiver coordinate system to a global map coordinate system.

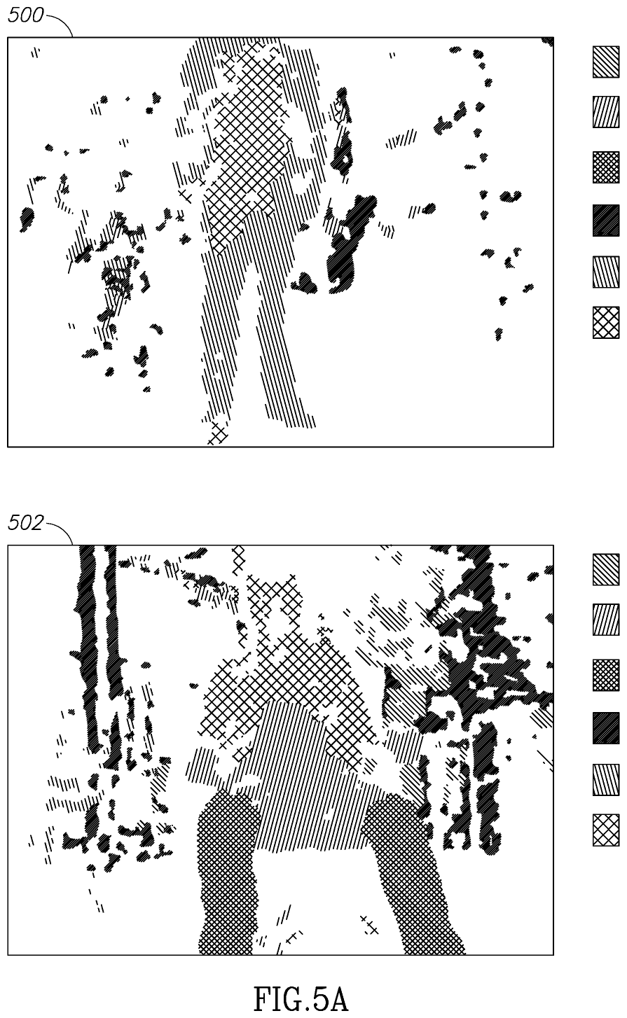

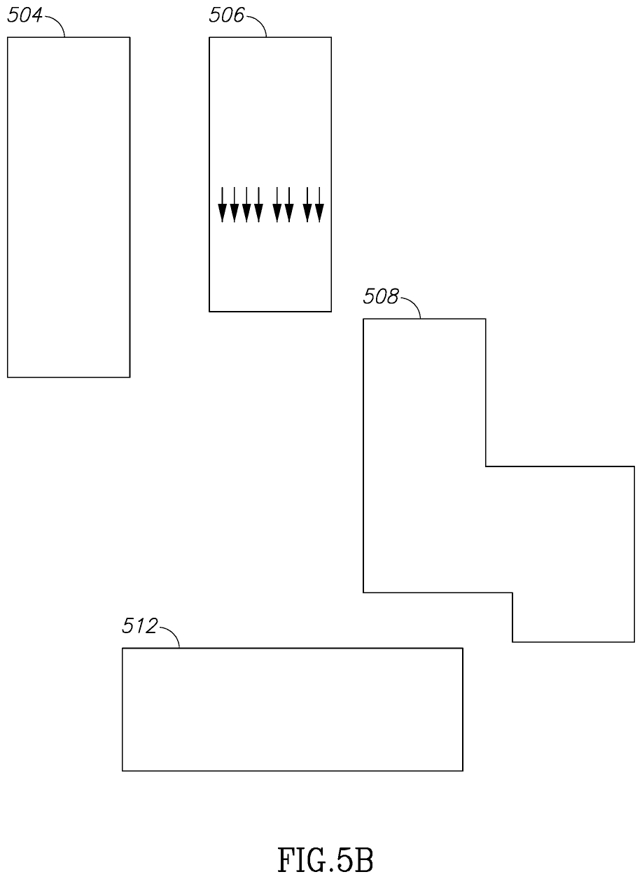

Referring now to FIGS. 5A and 5B. FIG. 5A shows a depth image 500 of a standing person and a depth image 502 of a person sitting facing the depth camera. Objects 504 and 506 of FIG. 5B represent the bounding rectangle of images 500 and 502, respectively.

The stages of FIG. 4A as detailed above may be performed by point segmentation module 228 disclosed above. It will be appreciated that the stages may be repeated for each full cycle of 360° (or less than that if the laser transmitter/receiver does not rotate in 360°).

Referring now back to FIG. 3, object detection and tracking stage 300 may further comprise object tracking stage 320.

Referring now to FIG. 4B, detailing object tracking stage 320. Object tracking stage 320 may include comparison stage 420, in which each of the rectangles determined for the current cycle is compared against all rectangles determined on a previous cycle.

If a rectangle from a current cycle and a rectangle from a previous cycle are the same, or substantially the same, the associated object may be considered a static object. If the two rectangles are substantially of the same size but at a different orientation, or if their location or orientation changed but the size stayed the same, then they may be considered the same object which is dynamic. If the rectangles do not comply with any of these criteria they are different. A rectangle having no matching rectangle from a previous cycle is considered a new object.

The stages of FIG. 4B as detailed above may be performed by object tracking and merging/splitting component 232 disclosed above.

Referring now back to FIG. 3, object detection and tracking stage 300 may further comprise object merging stage 324. On object merging stage 324, objects that are relatively small and close to each other, for example objects of up to about 20 cm and up to about 40 cm apart may be considered the same object. This situation may relate, for example, to two legs of a human, which are apart in some of the cycles and adjacent to each other at other cycles, and which may thus be considered one object. It will be appreciated that objects that split from other objects will be realized as new objects.

On stage 328, object features may be updated, such as associating an object identifier with the latest size, location, orientation, or the like.

In multiple experiments conducted as detailed below, surprising results have been achieved. The experiments have been conducted with a robot having velocity of 1.3 m/sec. The laser transmitter/receiver operates in 6 Hz and provides samples every 1 degree, thus providing 6*360=2160 samples every second. Dynamic objects have been detected and tracked without failure.

After objects have been identified and tracked, the pose of one or more objects may be classified on stage 304. It will be appreciated that pose classification stage 304 may take place for certain objects, such as objects of at least a predetermined size, only dynamic objects, at most a predetermined number of objects, such as one or two per scene, or the like.

Referring now to FIG. 4C, detailing pose classification stage 304.

Pose classification stage 304 may comprise location receiving stage 424 at which a location of an object assumed to be a human is received. The location may be received in coordinates relative to device 100, in absolute coordinates, or the like.

Pose classification stage 304 may comprise depth image receiving and processing stage 428, wherein the image may be received for example from a depth camera mounted on device 100, or at any other location. A depth image may comprise a depth indication for each pixel in the image. Processing may include segmenting the image based on the depth. For example, if two neighboring pixels have depth differences exceeding a predetermined threshold, the pixels may be considered as belonging to different objects, while if the depths are the same or close enough, for example the difference is below a predetermined value, the points may be considered as belonging to the same object. The pixels within the image may be segmented bottom up or in any other order.

Pose classification stage 304 may comprise stage 432 for calculating the gradient of the depth information along the vertical axis at each point of each found object, and sub-segmenting the object in accordance with the determined gradients.

Referring now back to FIGS. 5A and 5B, showing a depth image 500 of a standing person and a depth image 502 of a sitting person, and examples of bounding rectangles 504, 506, 508 and 512, wherein object 504 represents a bounding rectangle of depth image 500 and object 506 represents a bounding rectangle of depth image 502. It will be appreciated that the objects as segmented based on the depth information are not necessarily rectangle, and the objects of FIG. 5B are shown as rectangles for convenience reasons only.

Pose classification stage 304 may comprise stage 436 in which it may be determined whether the gradients at a lower part and at an upper part of an object are significantly different. If it is determined that the gradients are different, for example the difference exceeds a predetermined threshold, or that the object is generally not along a straight line, then it may be deduced that the human is sitting. Thus, since in the bounding rectangle shown as object 504 all areas are at substantially uniform distance for the depth camera, object 504 does not comprise significant gradient changes, and it is determined that the person is not sitting.

However, since bounding rectangle 506 of the person of image 502 does show substantial vertical gradients as marked, this indicates that the lower part is closer to the camera than the upper part, and therefore it is determined that the person may be sitting facing the camera.

On Stage 440, the height of the object may be determined, and if it is low, for example under about 1 m or another predetermined height and if the width of the object is more than 50 cm, for example, then it may be deduced that the human is lying down.

On Stage 444, if the height of the object is high, for example above 1 m, and the depth gradient is substantially zero over the object, then it may be deduced that the human is standing.

The stages of FIG. 4C as detailed above may be performed by pose classification module 236 disclosed above.

Referring now back to FIG. 3, once the object is tracked and the position is classified, the position of the device may change on stage 308. The position change may be adjusting the location of device 100, the height or the orientation of the device or part thereof, and may depend on the specific application or usage.

For example, on change location stage 332 device 100 may change its location. In accordance with deployment mode. For example, the device may follow the human, by getting to a location at a predetermined distance from the human in a direction opposite the advancement direction of the human. Alternatively, device 100 may be leading the human, for example getting to a location at a predetermined distance from the human in a direction in which the human should follow in order to get to a predetermined location. In yet another alternative, device 100 may be leading the human from the front, for example getting to a location at a predetermined distance from the human in the advancement direction of the human.

On height changing stage 336, the height of device 100 or part thereof such as tray 116 or display 112, may be adjusted such that it fits the height of the human, which may depend on the pose, for example standing, sitting or lying.

On orientation changing stage 336, the orientation of device 100 or part thereof such as tray 116 or display 112, may be adjusted, for example by rotating such that a human can access tray 116, view display 112, or the like. In order to determine the correct orientation, it may be assumed that a human face is in the direction in which the human is advancing.

Experiments have been conducted as detailed above. Experiments have been performed with people of height in the range of 160 cm and 195 cm, wherein the people were standing or sitting on any of five different chairs at various positions at distances varying from 50 cm to 2.5 m from the camera. Pose classification was successful in about 95% of the cases.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the parts of the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A robot comprising:
a sensor for capturing providing a collection of points in at least two dimensions, the points indicative of objects in an environment of the robot;
a processor adapted to perform the steps of:
receiving a collection of points in at least two dimensions;
segmenting the points according to distance to determine at least one object;
tracking the at least one object;
subject to at least two objects of size not exceeding a first threshold and at a distance not exceeding a second threshold, merging the at least two objects into a single object; and
classifying a pose of a human associated with the single object;
a steering mechanism or changing a position of the robot in accordance with the pose of the human; and
a motor for activating the steering mechanism.

2. A method for detecting a human in an indoor environment, comprising:
receiving a collection of points in at least two dimensions;
segmenting the points according to distance to determine at least one object;
tracking the at least one object;
subject to at least two objects of size not exceeding a first threshold and at a distance not exceeding a second threshold, merging the at least two objects into a single object; and
classifying a pose of a human associated with the single object.

3. The method of claim 2, further comprising:
receiving a series of range and angle pairs; and
transforming each range and angle pair to a point in a two dimensional space.

4. The method of claim 2, wherein segmenting the points comprises:
subject to a distance between two consecutive points not exceeding a threshold, determining that the two consecutive points belong to one object;
determining a minimal bounding rectangle for each object; and
adjusting the minimal bounding rectangle to obtain adjusted bounding rectangle for each object.

5. The method of claim 4, wherein tracking the at least one object comprises:
comparing the adjusted bounding rectangle to previously determined adjusted bounding rectangles to determine: a new object, a static object or a dynamic object, wherein a dynamic object is determined subject to at least one object and a previous object having substantially a same size but different orientation or different location.

6. The method of claim 2, wherein classifying the pose of the human comprises:
receiving a location of a human;
processing a depth image starting from the location and expending to neighboring pixels, wherein pixels having depth information differing in at most a third predetermined threshold are associated with one segment;
determining a gradient over a vertical axis for a multiplicity of areas of the one segment;
subject to the gradient differing in at least a fourth predetermined threshold between a lower part and an upper part of an object or the object not being substantially vertical, determining that the human is sitting;
subject to a height of the object not exceeding a fifth predetermined threshold, and a width of the object exceeding a sixth predetermined threshold determining that the human is lying; and
subject to a height of the object not exceeding the fifth predetermined threshold, and the gradient being substantially uniform determining that the human is standing.

7. The method of claim 6, further comprising sub-segmenting each segment in accordance with the gradient over the vertical axis.

8. The method of claim 6, further comprising smoothing the pose of the person by determining the pose that is most frequent within a latest predetermined number of determinations.

9. The method of claim 2, further comprising adjusting a position of a device in accordance with a location and pose of the human.

10. The method of claim 9, wherein adjusting the position of the device comprises performing an action selected from the group consisting of: changing a location of the device; changing a height of the device or a part thereof, and changing an orientation of the device or a part thereof.

11. The method of claim 9, wherein adjusting the position of the device is performed for taking an action selected from the group consisting of: following the human; leading the human; and following the human from a front side.

12. A computer program product comprising:
a non-transitory computer readable medium;
a first program instruction for receiving a collection of points in at least two dimensions;
a second program instruction for segmenting the points according to distance to determine at least one object;
a third program instruction for tracking the at least one object;
a fourth program instruction for subject to at least two objects of size not exceeding a first threshold and at a distance not exceeding a second threshold, merging the at least two objects; and
a fifth program instruction for classifying a pose of a human associated with the at least one object,
wherein said first, second, third, fourth, and fifth program instructions are stored on said non-transitory computer readable medium.

13. The computer program product of claim 12, further comprising program instructions stored on said non-transitory computer readable medium, the program instructions comprising:
a program instruction for receiving a series of range and angle pairs; and
a program instruction for transforming each range and angle pair to a point in a two dimensional space.

14. The computer program product of claim 12, wherein the second program instruction comprises:
a program instruction for determining that the two consecutive points belong to one object, subject to a distance between two consecutive points not exceeding a threshold;
a program instruction for determining a minimal bounding rectangle for each object; and
a program instruction for adjusting the minimal bounding rectangle to obtain adjusted bounding rectangle for each object.

15. The computer program product of claim 14, wherein the third program instruction comprises:
a program instruction for comparing the adjusted bounding rectangle to previously determined adjusted bounding rectangles to determine: a new object, a static object or a dynamic object, wherein a dynamic object is determined subject to at least one object and a previous object having substantially a same size but different orientation or different location.

16. The computer program product of claim 12, wherein the fifth program instruction comprises:
a program instruction for receiving a location of a human;
a program instruction for processing a depth image starting from the location and expending to neighboring pixels, wherein pixels having depth information differing in at most a third predetermined threshold are associated with one segment;
a program instruction for determining a gradient over a vertical axis for a multiplicity of areas of the one segment;
a program instruction for determining that the human is sitting subject to the gradient differing in at least a fourth predetermined threshold between a lower part and an upper part of an object or the object not being substantially vertical;
a program instruction for determining that the human is lying, subject to a height of the object not exceeding a fifth predetermined threshold, and a width of the object exceeding a sixth predetermined threshold; and
a program instruction for determining that the human is standing, subject to a height of the object not exceeding the fifth predetermined threshold, and the gradient being substantially uniform.

17. The computer program product of claim 16, further comprising a program instruction stored on said non-transitory computer readable medium for sub-segmenting each segment in accordance with the gradient over the vertical axis.

18. The computer program product of claim 16, further comprising a program instruction for smoothing the pose of the person by determining the pose that is most frequent within a latest predetermined number of determinations.

19. The computer program product of claim 12, further comprising a program instruction for adjusting a position of a device in accordance with a location and pose of the human.

20. The computer program product of claim 19, wherein the program instruction for adjusting the position of the device is executed for performing an action selected from the group consisting of: changing a location of the device; changing a height of the device or a part thereof; changing an orientation of the device or a part thereof; following the human; leading the human; and following the human from a front side.

21. (canceled)
